(19) United States
(12) Patent Application Publication
(10) Pub. No.: US 2002/0015484 A1
(43) Pub. Date: Feb. 7, 2002

(54) Automatic answering mode changing over method according to caller numbers

(75) Inventor: Sun-Young Maeng, Seoul (KR)

Correspondence Address: Paul J. Farrell, Esq., Dilworth & Barrese, LLP, 333 Earle Ovington Blvd., Uniondale, NY, 11553, US

(73) Assignee: SAMSUNG ELECTRONICS CO., LTD., KYUNGKI-DO (KR)

(21) Appl. No.: 09/820,548

(22) Filed: Mar. 29, 2001

(30) Foreign Application Priority Data
Jun. 1, 2000 (KR) 2000-30020

(51) Int. Cl. H04M 11/00

(52) U.S. Cl. 379/142.1; 379/93.02

(57) ABSTRACT

There is provided a method for controlling an automatic answering mode function in a telephone having an automatic answering function, a caller identification function, and a telephone directory function. According to the method, an automatic answering mode is set to be on or off for telephone numbers registered in the telephone directory and unregistered telephone numbers according to the user's choice. Upon incoming of a call, a received caller number is identified. It is determined whether the received caller number is registered in the telephone directory. The setting state of the automatic answering mode for the caller number is checked if the caller number is registered in the telephone directory. The setting state of the automatic answering mode for the unregistered telephone numbers is checked if the caller number is not registered in the telephone directory. If the setting state of the automatic answering mode is on, the telephone is switched to the automatic answering mode. If the setting state of the automatic answering mode is off, the call is processed in a normal operation without switching to the automatic answering mode.

### PRIORITY

This application claims priority to an application entitled “Automatic Answering Mode Changing Over Method According to Callers” filed in the Korean Industrial Property Office on Jun. 1, 2000 and assigned Serial No. 2000-30020, the contents of which are hereby incorporated by reference.

### BACKGROUND OF THE INVENTION

1. Field of the Invention

The present invention relates generally to a telephone having an automatic answering function, a caller identification function, and a telephone directory function, and in particular, to a method for implementing an automatic answering function.

2. Description of the Related Art

Diverse telephony services have been developed that focus on privacy, individuality, and personality. Answering an incoming call is given priority regardless of what function a called telephone is engaged in at the moment. For this purpose, an automatic answering function and a caller identification function have been developed respectively to answer a call while a called telephone is engaged in a function and to identify the number of a caller.

The need for the caller identification function has recently been pressing. In some countries, it is provided as a basic service. To allow a called party to identify the number of a caller, a calling telephone or an exchange transmits the number of the calling telephone to a called telephone. This function is commonly referred to as “CID” or “Caller Identification”. Then, the called telephone having the caller identification function detects the caller number and displays it on a display.

As compared to such a telephone with the caller identification function, however, a conventional telephone capable of automatically answering a call or an Internet phone that has recently been used is changed over (or switched) to an automatic answering mode regardless of the origin of the call when a call is incoming. That is, upon the incoming of a call to a telephone with the automatic answering function turned on, the telephone is automatically changed over to the automatic answering mode and answers the call. When the automatic answering function is off, the incoming call is processed without automatic answering.

Therefore, when a call is incoming with the automatic answering mode set, a called telephone is automatically changed over to the automatic answering mode regardless of the origin of the call, or a called party invokes the automatic answering function when he considers it necessary after he checks a caller number from a display upon receipt of an incoming call.

According to Korean patent application No. 1997-19462, assigned to the applicant, entitled “Selective Incoming Message Receiving Method Using CID in Automatic Answering Device”, telephone numbers are registered in advance. Upon incoming of a call, it is automatically answered only when a CID is identical to a registered number, an outgoing message is sent, and an incoming message is recorded.

Despite the advantage of preventing receipt of a mischievous call or facsimile, the above method cannot selectively set the automatic answering mode with respect to unregistered telephone numbers. Besides, in the case of an automatic answering telephone with a telephone directory where a plurality of telephone numbers are registered together with corresponding names, the telephone numbers need to be separately registered for automatic answering.

### SUMMARY OF THE INVENTION

It is, therefore, an object of the present invention to provide a method of selectively providing an automatic answering function according to a caller in a user-convenient manner.

It is another object of the present invention to provide a method of selectively providing an automatic answering function to unregistered callers.

To achieve the above objects, an automatic answering mode is set to be on or off for telephone numbers registered in a telephone directory and unregistered telephone numbers according to user choice. Upon incoming of a call, a received caller number is identified. It is determined whether the received caller number is registered in the telephone directory. The setting state of the automatic answering mode for the caller number is checked if the caller number is registered in the telephone directory. The setting state of the automatic answering mode for unregistered telephone numbers is checked if the caller number is not registered in the telephone directory. If the setting state of the automatic answering mode is on, the telephone is changed over to the automatic answering mode. If the setting state of the automatic answering mode is off, the call is processed in a normal operation without changing over to the automatic answering mode.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a typical automatic answering telephone to which the present invention is applied;

FIG. 2 is a schematic block diagram of software modules for automatic answering in a controller 100 shown in FIG. 1;

FIG. 3 is a flowchart illustrating an automatic answering mode setting operation according to an embodiment of the present invention; and

FIG. 4 is a flowchart illustrating an incoming call processing operation according to the embodiment of the present invention.

### DETAILED DESCRIPTION OF THE PREFERRED EMBODIMENT

A preferred embodiment of the present invention will be described hereinbelow with reference to the accompanying drawings. In the following description, well-known functions or constructions are not described in detail since they would obscure the invention in unnecessary detail.

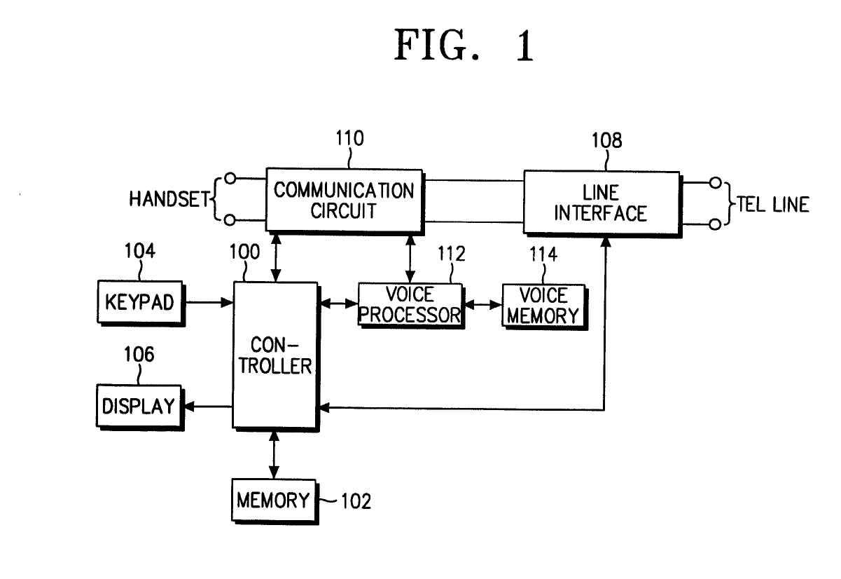

FIG. 1 is a block diagram of a typical automatic answering telephone having an automatic answering function, a caller identification function, and a telephone directory function, to which the present invention is applied. Referring to FIG. 1, the automatic answering telephone is comprised of a controller 100, a memory 102, a keypad 104, a display 106, a line interface 108, a communication circuit 110, a voice processor 112, and a voice memory 114. The controller 100 provides overall control to the automatic answering telephone, including key input and call termination, performs a typical call process and automatic answering function, and provides an automatic answering mode change-over function according to an embodiment of the present invention. The memory 102 connected to the controller 100 has a ROM (Read Only memory), flash memory, and a RAM (Random Access Memory). The ROM stores control programs and various reference data for the controller 100 and the RAM serves as a working memory for the controller 100. The flash memory stores updatable data to be kept and a telephone directory that will be described later.

The keypad 104 is provided with a plurality of keys including digit keys and feeds key input signals to the controller 100. The display 106 is typically an LCD (Liquid Crystal Display) and displays information graphically under the control of the controller 100. The line interface 108, connected between the communication circuit 110 and a telephone line and connected to the controller 100, interfaces with the telephone line. The line interface 108 receives a ring signal or detects a CID and transmits the ring signal or the CID to the controller 100. The communication circuit 110, connected between the line interface 108 and a telephone handset and connected to the controller 100, transmits/receives a voice signal between the handset/the voice processor 112 and the line interface 108. The voice processor 112 and the voice memory 114 are used for automatic answering. The voice processor 112 reads the voice data of an outgoing message from the voice memory 114, converts the voice data to a voice signal, and transmits the voice signal to the telephone line via the communication circuit 110 under the control of the controller 100. The voice processor 112 also converts the voice signal of an incoming message received via the communication circuit 110 to voice data and stores the voice data in the voice memory 114.

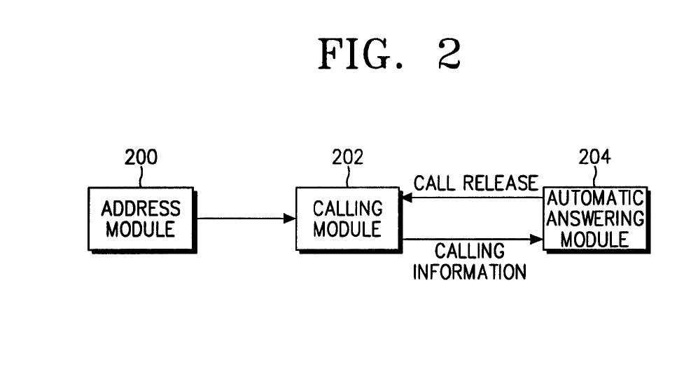

FIG. 2 is a block diagram of software modules for automatic answering in the controller 100 shown in FIG. 1. The software modules are an address module 200, a calling module 202, and an answering module 204. The address module 200 stores a telephone directory where telephone numbers and their corresponding names are registered in the memory 102 and provides the registered telephone numbers to the calling module 202. The calling module 202 processes an incoming call and an outgoing call and feeds calling information to the answering module 204 for a changeover to the automatic answering mode when the automatic answering mode is set. The answering module 204 operates according to the calling information received from the calling module 202 and notifies the calling module of call release when the automatic answering function is over.

A telephone directory database of the address module 200 according to the present invention additionally has an unregistered address field and a field indicating on/off of the automatic answering mode for each telephone number, as shown in Table 1.

TABLE 1

| | | | | | OGM |
|---|---|---|---|---|---|
| | | | | | reproduction |
| No | Name | Phone number | ... | category | bit |
| 1 | AAAAAAA | 011-111-2222 | | | “1” |
| 2 | BBBBBBB | 016-111-2222 | | | “0” |
| 3 | CCCCCCC | 017-111-2222 | | | “0” |
| . | | | | | |
| . | | | | | |
| . | | | | | |
| n | | | | | |
| n + 1 | Unregistered | | | | “1” |

Table 1 is an example of a telephone directory for an Internet phone, with an OGM (Outgoing Message) field and an unregistered address in addition to the conventional fields of telephone number and category of a typical telephone directory. The last address (n+1) is the unregistered address.

The OGM reproduction bit is set to 1 for turning on the automatic answering mode and to 0 for turning off the automatic answering mode. Therefore, the automatic answering mode can be on/off according to specific telephone numbers as a user selects.

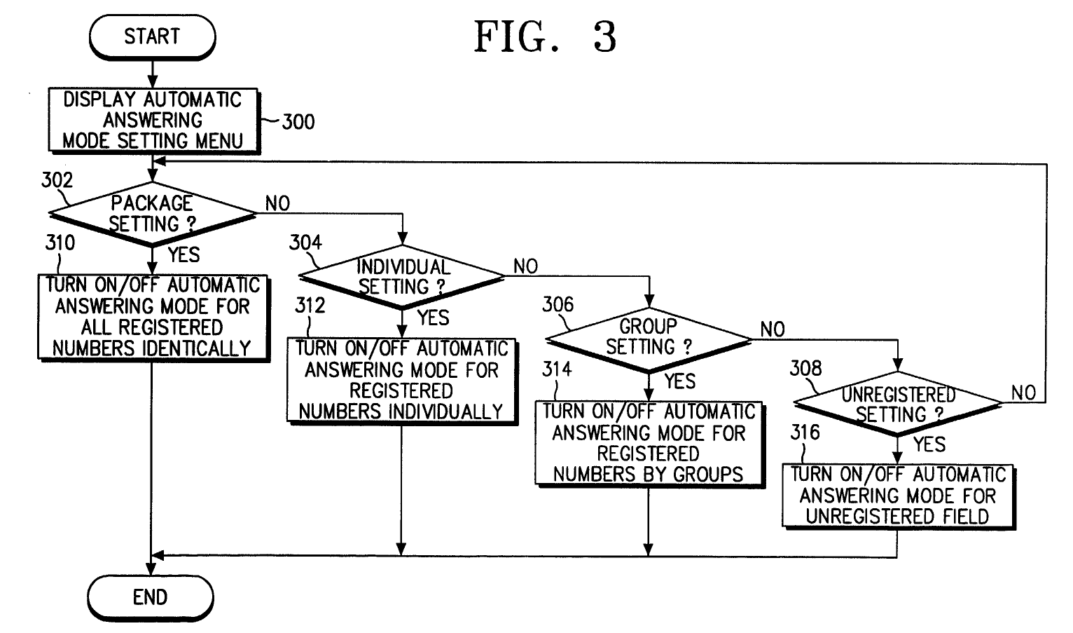

An automatic answering mode setting operation in the controller 100 according to the embodiment of the present invention will be described with reference to FIG. 3. In FIG. 3, if the user selects an automatic answering mode setting menu via the keypad 104, the controller 100 displays the menu on the display 106 at step 300 as

1. package setting
2. individual setting
3. group setting
4. unregistered setting

The above automatic answering mode setting menu allows a called party to set the automatic mode to be on or off for the registered telephone number in one of the three manners according to the selection of the called party or to set the automatic answering mode to be on or off for an unregistered telephone number, by way of example. The user selects an intended menu item number via the keypad 104.

The controller 100 receives the selection of the user while the automatic answering mode menu is displayed, in steps 302 to 308. If the user selects package setting at step 302, the controller 100 sets the automatic answering mode to be on/off for all the registered telephone numbers according to the selection of the user via the keypad 104 in step 310. That is, the registered telephone numbers are all set to the automatic answering mode or none of them are set to the automatic answering mode. If the user selects individual setting at step 304, the controller 100 individually sets the automatic answering mode to be on/off for the registered telephone numbers according to the user's choice via the keypad 104 in step 312. That is, the automatic answering mode is set to be on or off for the registered telephone numbers individually as the user wants. If the user selects group setting at step 306, the controller 100 sets the automatic answering mode to be on/off for the registered telephone number by groups in step 314. That is, the registered telephone numbers are categorized and managed by categories as in the Internet phone. Only one setting type may be applied to a real product or a user may select his intended setting type as in a typical menu.

If the user selects unregistered setting at step 308, the controller 100 sets the automatic answering mode to be on/off for an unregistered address in the telephone directory according to the user's choice via the keypad 104 in step 316.

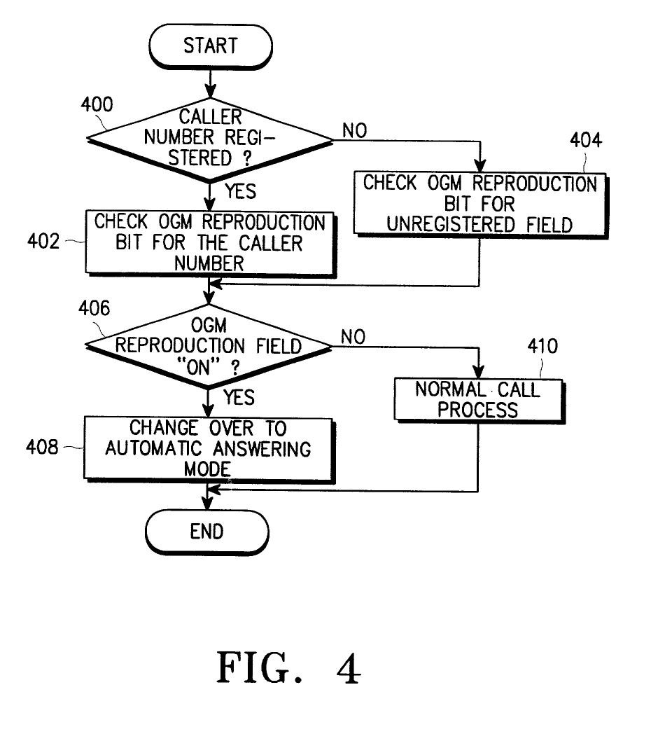

After the automatic answering mode is set to be on/off for the telephone numbers in the setting type as the user selects, when a call is coming, the calling module 202 in the controller 100 operates in a procedure shown in FIG. 4. FIG. 4 is a flowchart illustrating the operation of the calling module 202 according to the embodiment of the present invention.

Upon the incoming of a call, the calling module 202 identifies a received caller number. In this state, the calling module 202 determines whether the caller number is registered in the telephone directory of the address module 200 in step 400. If the caller number is registered, the calling module 202 checks the on/off state of the automatic answering mode for the caller number, referring to the OGM reproduction bit of the caller number in step 402 and 406. On the other hand, if the caller number is not registered, the calling module 202 checks the on/off state of the automatic answering mode for the caller number, referring to the OGM reproduction bit of the unregistered address in step 404 and 406.

If the OGM reproduction bit indicates the on-state of the automatic answering mode in step 406, the calling module 202 changes over the telephone to the automatic answering mode by transmitting calling information to the automatic answering module 204 in step 408. Accordingly, the automatic answering function is implemented for an incoming call from a caller for which the automatic answering mode is set regardless of registered or unregistered.

On the contrary, if the automatic answering mode is not set for the caller number, the calling module 202 processes the call in a normal way without changing over the telephone to the automatic answering mode in step 410. Therefore, the incoming call is processed in the normal way if the automatic answering mode is not set for the caller number regardless of whether it is registered or unregistered.

Consequently, the automatic answering function is selectively provided as a called party intends. The automatic answering mode can selectively be set for unregistered telephone numbers and also for registered telephone numbers in an automatic answering telephone with a telephone directory, which obviates the need of separately registering the telephone numbers for automatic answering.

While the invention has been shown and described with reference to a certain preferred embodiment thereof, it will be understood by those skilled in the art that various changes in form and details may be made therein without departing from the spirit and scope of the invention. Especially though the present invention has been described in context with a telephone capable of detecting a caller number, it is also applicable to a telephone for which a CID service is provided at a certain charge. By the CID service, a message requesting a caller to leave a message is transmitted to the caller. Therefore, the scope and spirit of the invention is defined by the appended claims.

What is claimed is:

1. A method for controlling an automatic answering mode function in a telephone, the telephone having an automatic answering function, a caller identification function, and a telephone directory function, comprising the steps of:
(a) setting an automatic answering mode to one of on and off for telephone numbers registered in the telephone directory and unregistered telephone numbers according to user choice;
(b) identifying a received caller number upon incoming of a call;
(c) determining whether the received caller number is registered in the telephone directory;
(d) checking a status of the automatic answering mode as set in step (a) for the caller number if the caller number is registered in the telephone directory;
(e) checking the status of the automatic answering mode as set in step (a) for the unregistered telephone numbers if the caller number is not registered in the telephone directory;
(f) switching the telephone to the automatic answering mode if the status of the automatic answering mode is on; and
(g) processing the call in a normal operation without switching to the automatic answering mode if the status of the automatic answering mode is off.

2. The method of claim 1, wherein the automatic answering mode is set to one of on and off for all of the registered telephone numbers according to the user's choice.

3. The method of claim 1, wherein the automatic answering mode is set to one of on and off for each of the registered telephone numbers individually according to the user's choice.

4. The method of claim 1, wherein the automatic answering mode is set to one of on and off for the registered telephone numbers by groups according to the user's choice.

5. A method for controlling an automatic answering mode function in a telephone, the telephone having an automatic answering function, a caller identification function, and a telephone directory function, comprising the steps of:
(a) setting an automatic answering mode to one of on and off for the telephone numbers registered in the telephone directory according to user choice;
(b) identifying a received caller number upon incoming of a call;
(c) determining whether the received caller number is registered in the telephone directory;
(d) checking a status of the automatic answering mode as set in step (a) for the caller number if the caller number is registered in the telephone directory;
(e) switching the telephone to the automatic answering mode if the status of the automatic answering mode is on; and
(f) processing the call in a normal operation without switching to the automatic answering mode if the status of the automatic answering mode is off or if the received caller number is unregistered.

6. A method for controlling an automatic answering mode function in a telephone, the telephone having an automatic answering function, a caller identification function, and a telephone directory function, comprising the steps of:
(a) setting an automatic answering mode to one of on and off for the unregistered telephone numbers according to user choice;
(b) identifying a received caller number upon incoming of a call;
(c) determining whether the received caller number is registered in the telephone directory;
(d) checking the status of the automatic answering mode as set in step (a) for the unregistered telephone numbers if the caller number is not registered in the telephone directory;
(e) switching the telephone to the automatic answering mode if the status of the automatic answering mode is on; and
(f) processing the call in a normal operation without switching to the automatic answering mode if the status of the automatic answering mode is off.
